(19) United States
(12) Patent Application Publication
(10) Pub. No.: US 2011/0127247 A1
(43) Pub. Date: Jun. 2, 2011

(54) PRE-HEATER APPARATUS FOR VEHICLE

(75) Inventors: Jae Sik Choi, Suwon-si (KR); Hak Kyu Kim, Daejeon (KR); Do Sik Min, Cheongju-si (KR); Jong Eob Kim, Cheongwon-gun (KR)

(73) Assignees: Hyundai Motor Company, Seoul (KR); Halla Climate Control Corp., Daejeon-si (KR); Jahwa Electronics Co., Ltd., Cheongwon-gun (KR)

(21) Appl. No.: 12/912,356

(22) Filed: Oct. 26, 2010

(30) Foreign Application Priority Data
Dec. 2, 2009 (KR) 10-2009-0118422
May 28, 2010 (KR) 10-2010-0050317

(51) Int. Cl. B60L 1/02

(52) U.S. Cl. 219/202

(57) ABSTRACT

A pre-heater apparatus for a vehicle includes a heat sink having a plurality of radiating fins which are layered, a Positive Temperature Coefficient (PTC) assembly inserted into the heat sink to be assembled therewith, and a housing. The pre-heater apparatus is mounted to a duct which is adjacent to a discharge duct, thus improving the performance of heating an interior when the vehicle is initially starting, and improving heat efficiency.

### CROSS-REFERENCE TO RELATED APPLICATIONS

The present application claims priority to Korean Patent Application Number 10-2009-0118422 filed on Dec. 2, 2009 and Korean Patent Application Number 10-2010-0050317 filed on May 28, 2010, the entire contents of which applications is incorporated herein for all purpose by this reference.

### BACKGROUND OF THE INVENTION

1. Field of the Invention

The present invention relates, in general, to pre-heater apparatuses for vehicles and, more particularly, to a pre-heater apparatus for a vehicle which is installed in a duct to improve heating efficiency using a Positive Temperature Coefficient (“PTC”) element.

2. Description of the Related Art

Generally, a vehicle is equipped with a heater apparatus which uses the thermal energy of a coolant warmed up by the heat of an engine so as to heat the interior of the vehicle, dehumidify or defrost the windshield of the vehicle.

In such a heater apparatus, since the engine starts running and then the coolant flowing around the engine enters the heater apparatus, it takes a long time to heat the coolant and then heat the interior. Thus, the heater apparatus has the disadvantage of a passenger having to be in the cold for a certain period of time after the engine has been started.

In recent years, pre-heater apparatuses using Positive Temperature Coefficient (PTC) elements have been mounted to all the seats of a vehicle. Thus, as soon as the vehicle is started in the winter, electric energy is converted into thermal energy, so that the pre-heater apparatuses operate until the temperature of the coolant rises and can make the interior warm. Here, the PTC element is a kind of n-type oxide semiconductor which is produced by adding a very small amount of rare-earth element to BaTiO₃ to provide conductivity and substituting Sr or Pb for some of the Ba to change the curie temperature. When the PTC element reaches a certain temperature, the resistance of the PTC element increases rapidly as the temperature rises because of a phase transition. That is, the PTC element is characterized in that the resistance increases rapidly at a predetermined temperature, the curie temperature.

FIG. 10 is a perspective view illustrating a conventional pre-heater apparatus for a vehicle using a PTC element, and FIG. 11 is an exploded view illustrating the conventional pre-heater apparatus for the vehicle.

As shown in FIGS. 10 and 11, the conventional pre-heater apparatus mainly includes terminal parts for supplying power, heaters or heating parts 11 having PTC elements which receive power from the terminal parts and emit heat, radiators or heat radiating parts 12 which are in contact with the heating parts 11 to effectively radiate heat, and a housing 20 which surrounds and protects the terminal parts, the heating parts 11, and the heat radiating parts 12. A great number of heat radiating holes 20a is formed in a surface of the housing 20 to effectively radiate the heat of the heat radiating parts 12 outside the housing 20. Thus, the heat radiating parts 12 increase the temperature of air as it passes through the heat radiating holes 20a. The terminal parts, the heating parts 11, and the heat radiating part 12 are put in the housing 20 which has been disassembled. The disassembled housing 20 is assembled using general fastening means, for example, screws, hooks, and fastening pins.

The conventional pre-heater apparatus for the vehicle is mounted to the heater apparatus of the vehicle, and is problematic in that the heat it generates is small in heating capacity, so that the heat is not sufficiently transmitted through a duct to a passenger. Particularly, the conventional pre-heater apparatus for the vehicle is problematic in that air passes through the heat radiating parts in a transverse direction thereof, so that heat exchange of the air with the PTC elements is small for the short length of the passage. Further, the conventional pre-heater apparatus for the vehicle is problematic in that it is mounted to only the inside of an air conditioning system, so that the availability of the pre-heater apparatus is poor in terms of packaging.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Accordingly, the present invention has been made keeping in mind the above problems occurring in the related art, and the present invention provides for a pre-heater apparatus for a vehicle which is intended to maximize the heating performance using a PTC element.

According to one aspect of the present invention, there is provided a pre-heater apparatus for a vehicle. The pre-heater apparatus includes a heat sink having a plurality of radiating fins which are layered, with an air path formed between the radiating fins. A PTC assembly has a terminal unit for supplying power and a PTC element which receives the power from the terminal unit to generate heat, and is inserted into the heat sink in such a way as to be parallel to the air path. A housing surrounds the heat sink, and has an inlet and an outlet on first and second ends of the air path in such a way that the inlet and the outlet are opposite to each other, with a duct-fastening hook provided in each of the inlet and the outlet to be fastened to a duct.

The housing may be assembled between an air conditioning duct in which conditioned air flows and a discharge duct through which the conditioned air is discharged, and the duct-fastening hook of the housing may have the shape of a protrusion which is snap-fitted into a fitting hole of each of the air conditioning duct and the discharge duct.

The housing may be made of a polymer material which is more resistant to thermal deformation resulting from high temperature, compared to the air conditioning duct and the discharge duct.

A flange-shaped support may be provided around each of the inlet and the outlet of the housing, and may be in close contact with an outer surface of each of the air conditioning duct and the discharge duct when the housing is coupled to the duct.

The PTC assembly may be placed in a longitudinal direction of the heat sink in such a way as to be perpendicular to the heat sink.

One or more PTC assemblies may be placed side by side in the heat sink.

A plurality of PTC assemblies may be constructed to be operated starting from a PTC assembly adjacent to the outlet of the housing, depending on how much heat it is required to provide.

The plurality of PTC assemblies may comprise terminal units, respectively, and power may be independently applied to the respective terminal units.

A plurality of heat sinks may be arranged side by side in the housing to define a continuous air path, and PTC assemblies may be inserted, respectively, into the corresponding heat sinks in such a way as to be placed on the same plane.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an exploded perspective view illustrating an exemplary pre-heater apparatus for a vehicle according to the present invention.

FIG. 2 is a perspective view illustrating the exemplary pre-heater apparatus of FIG. 1.

FIG. 3 is another exploded perspective view illustrating the exemplary pre-heater apparatus of FIG. 1.

FIG. 4 is a perspective view illustrating the assembly of the exemplary pre-heater apparatus of FIG. 1.

FIG. 5 is another perspective view illustrating the assembly of the exemplary pre-heater apparatus of FIG. 1.

FIG. 6 is a plan view illustrating the exemplary pre-heater apparatus of FIG. 1.

FIG. 7 is a sectional view taken along line A-A of FIG. 6 to illustrate the exemplary pre-heater apparatus.

FIG. 8 is a view illustrating the operation of the pre-heater apparatus of FIG. 1.

FIG. 9 is another view illustrating the operation of the pre-heater apparatus of FIG. 1.

FIG. 10 is a perspective view illustrating a conventional pre-heater apparatus for a vehicle.

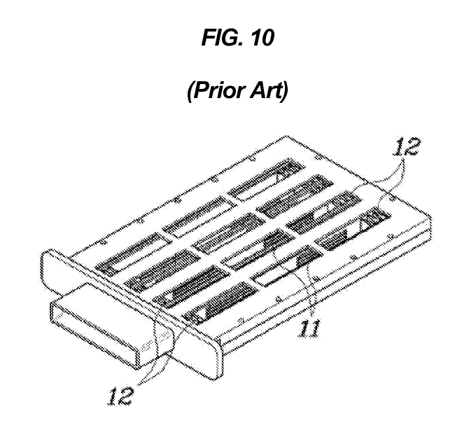

FIG. 11 is an exploded perspective view illustrating the conventional pre-heater apparatus for the vehicle of FIG. 10.

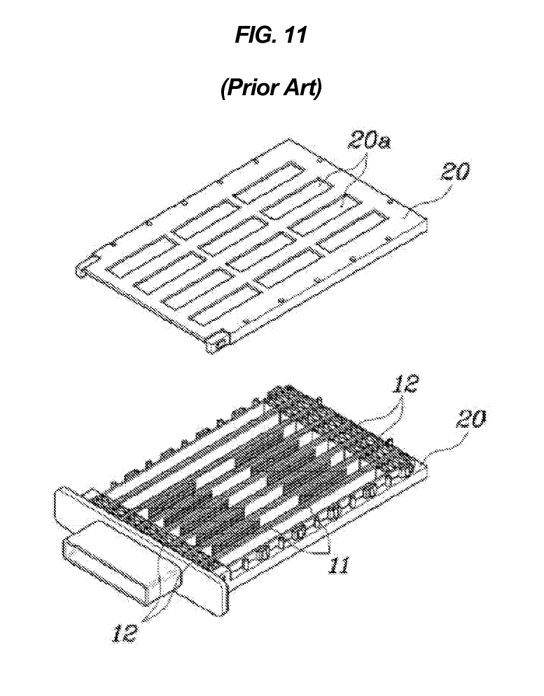

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

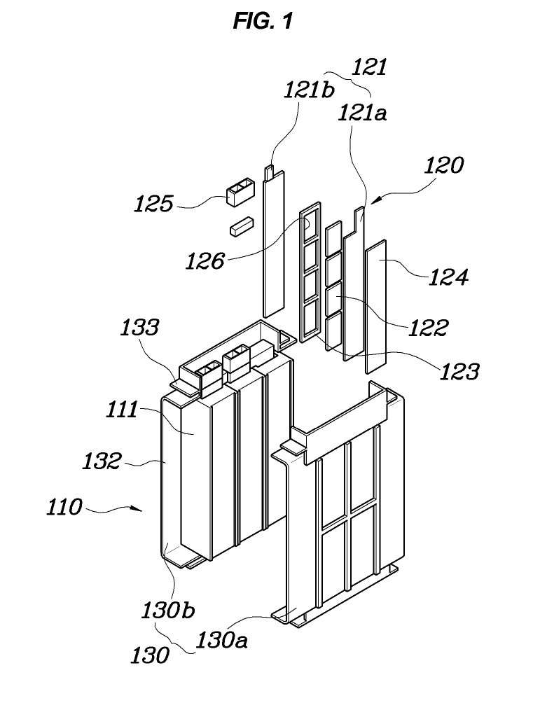

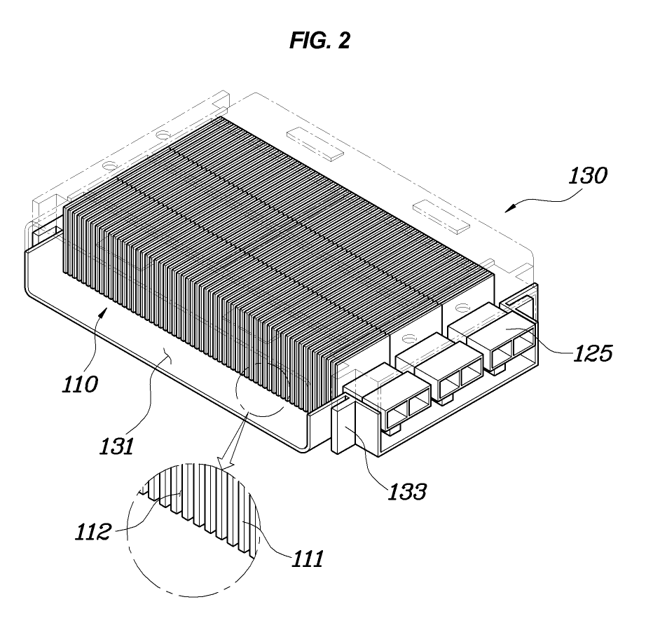

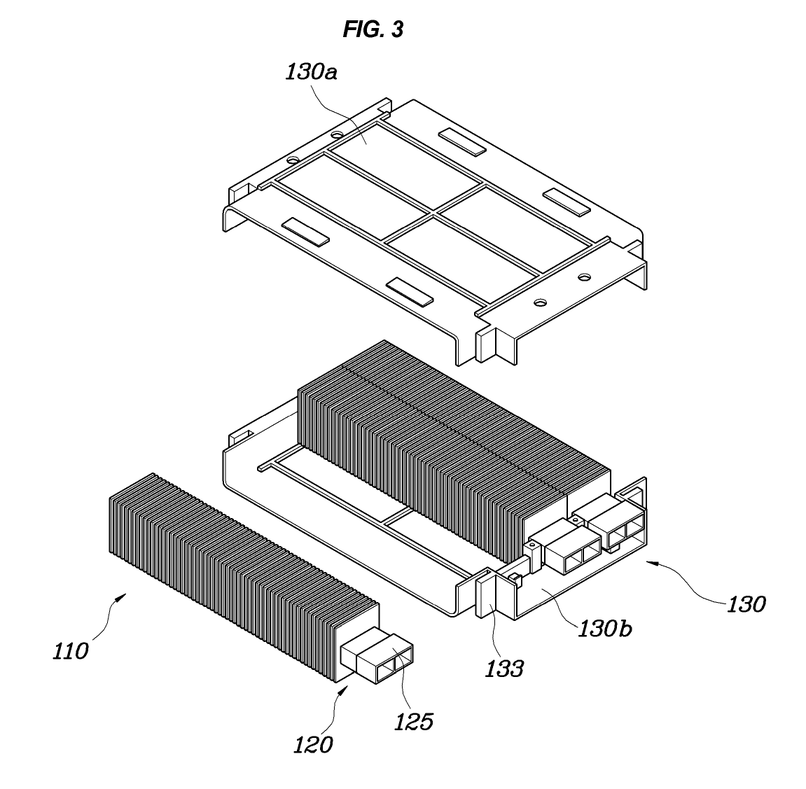

FIG. 1 is an exploded perspective view illustrating a pre-heater apparatus for a vehicle according to various embodiments of the present invention, FIG. 2 is a perspective view illustrating the pre-heater apparatus for the vehicle of FIG. 1, and FIG. 3 is another exploded perspective view illustrating the pre-heater apparatus for the vehicle of FIG. 1. The pre-heater apparatus for the vehicle according to the present invention includes a heat sink 110, a PTC assembly 120, and a housing 130. The heat sink 110 has a plurality of radiating fins 111 which are layered, with an air path 112 formed between neighboring radiating fins 111. The PTC assembly 120 has a terminal unit 121 for supplying power and a PTC element 122 which receives the power from the terminal unit 121 to generate heat. The PTC assembly 120 is inserted into the heat sink 110 in such a way as to be parallel to the air path 112. The housing 130 surrounds the heat sink 110, has an inlet 131 and an outlet 132 on opposite ends of the air path 112 in such a way that the inlet 131 and the outlet 132 are opposite to each other. A duct-fastening hook 135 is provided in each of the inlet 131 and the outlet 132 to be fastened to a duct.

In detail, the PTC assembly 120 includes the terminal unit 121 for supplying power, the PTC element 122 which receives power from the terminal unit 121 to generate heat, a guide member 123 which has a seating hole 126 to allow the PTC element 122 to be seated therein, and an insulator 124 for insulating the terminal unit 121.

Here, the terminal unit 121 includes a positive terminal 121a and a negative terminal 121b, and is mounted to a socket 125. The heat generated from the PTC element 122 is transmitted to the heat sink 110 which is in contact with the PTC element 122, so that heat is radiated. Since the detailed construction of the PTC assembly 120 is widely known to those skilled in the art, a detailed description thereof will be omitted.

However, according to the present invention, the PTC assembly 120 is assembled perpendicular to the heat sink 110 and thus is parallel with the direction in which the air flows. In other words, the PTC assembly 120 is arranged in the longitudinal direction of the heat sink 110 to be perpendicular to the heat sink 110.

Thereby, while air moves in the longitudinal direction of the heat sink 110, heat exchange may be implemented between the PTC assembly 120 and the heat sink 110. As such, in the present invention, air moves in the longitudinal direction of the heat sink 110 which is long. In contrast, in the conventional pre-heater apparatus for the vehicle, air moves in the transverse direction of the heat sink 110 which is narrow. Therefore, the present invention extends the time that heat exchange is performed compared to the conventional pre-heater apparatus, thus improving heating performance.

The heat sink 110 has a multi-layered fin structure formed by layering the plurality of radiating fins 111. The air path 112 is formed between the radiating fins 111 so that air circulates through the air path 112.

The housing 130 is a casing that accommodates the heat sink 110 and the PTC assembly 120 therein, and is separated from a first housing part 130a which surrounds one side of the heat sink 110 and a second housing part 130b which surrounds the other side of the heat sink 110.

Since the housing 130 is constructed to surround the heat sink 110, the housing 130 is made of a polymer material which can withstand the high temperature of the PTC element 122. Preferably, the housing 130 is made of a polymer material which is more resistant to thermal deformation resulting from high temperature, as compared to the material of surrounding ducts.

The inlet 131 through which air enters the housing 130 and the outlet 132 through which the air is discharged from the housing 130 are formed in the housing 130. The inlet 131 is formed on one end of the heat sink 110 in the longitudinal direction thereof, while the outlet 132 is formed on the other end of the heat sink 110 in the longitudinal direction thereof to be opposite to the inlet 131. Thus, while the air entering the housing 130 through the inlet 131 moves in the longitudinal direction of the heat sink 110, heat exchange is performed between the air and the heat sink 110, and thereafter the air is discharged through the outlet 132.

The PTC assembly 120 may be inserted into the heat sink 110 to provide a single module. In this case, one heat sink 110 may be installed in the housing 130 and a plurality of PTC assemblies 120 may be inserted into the heat sink 110. However, one heat sink 110 may be coupled to one PTC assembly 120 to form one module, a plurality of heat sinks 110 may be arranged side by side in the housing 130 to form a continuous air path, and the PTC assemblies 120 may be inserted, respectively, into the corresponding heat sinks 110 in such a way as to be placed on the same plane. Such a structure is advantageous in that the PTC assembly 120 and the heat sink 110 may be replaced and repaired as a single module.

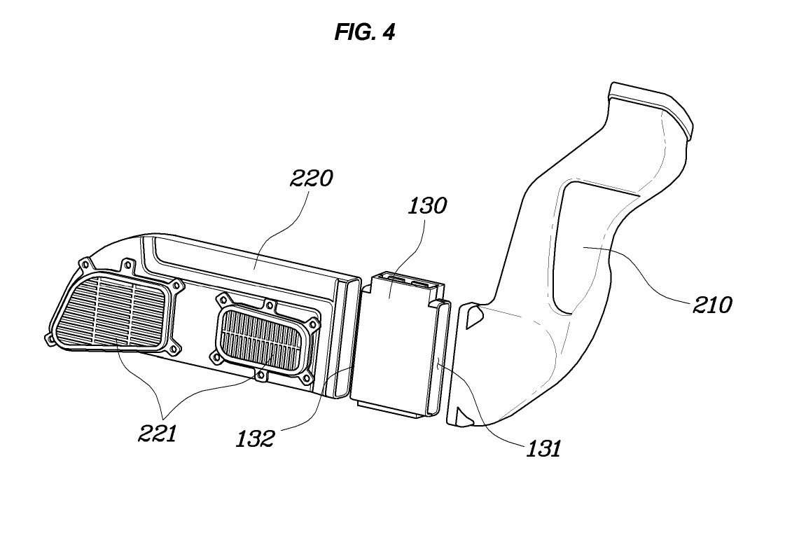

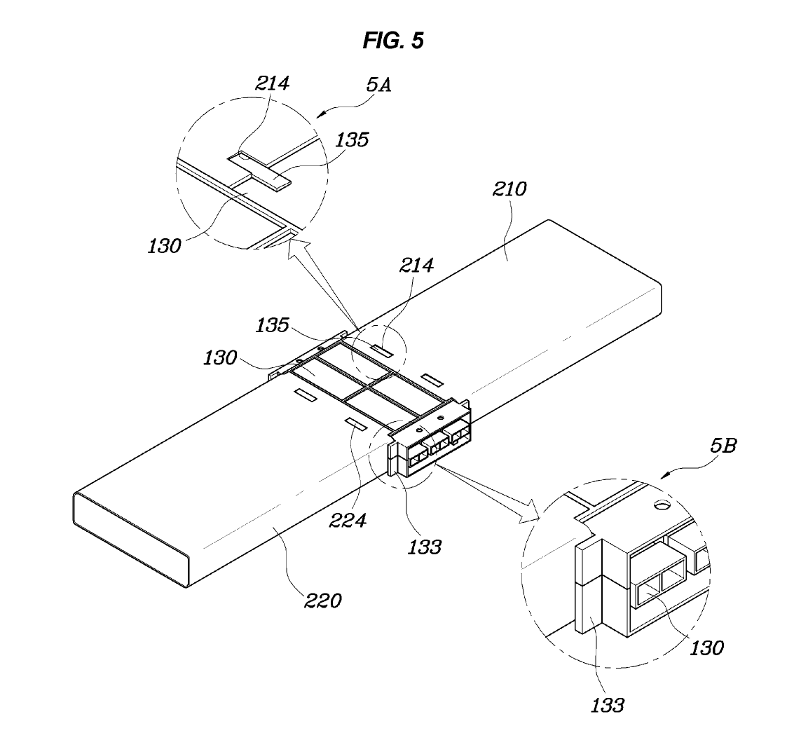

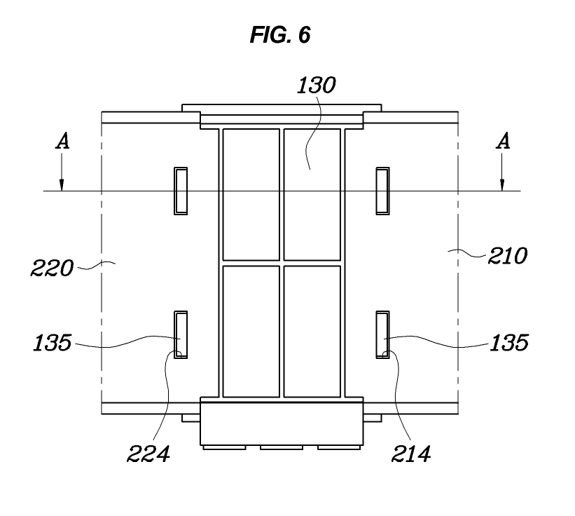

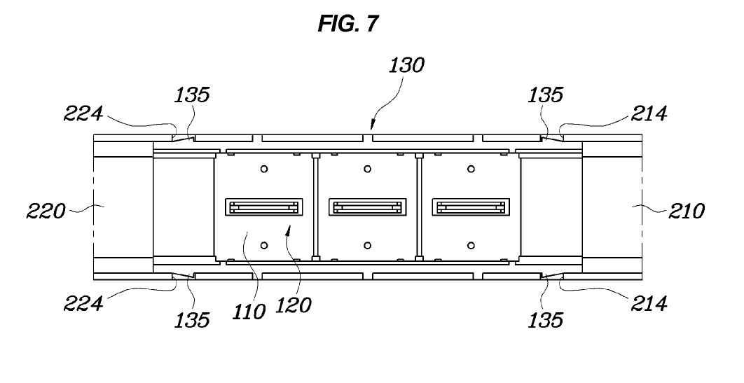

FIG. 4 is a perspective view illustrating the assembly of the pre-heater apparatus for the vehicle, FIG. 5 is another perspective view illustrating the assembly of the pre-heater apparatus for the vehicle, FIG. 6 is a plan view illustrating the pre-heater apparatus for the vehicle, and FIG. 7 is a sectional view taken along line A-A of FIG. 6 to illustrate the pre-heater apparatus for the vehicle.

As shown in FIGS. 4 and 5, the housing 130 is assembled between an air conditioning duct 210 in which conditioned air flows and a discharge duct 220 through which such air is discharged. The duct-fastening hook 135 of the housing 130 may have the shape of a protrusion which is snap-fitted into a fitting hole 214 of the air conditioning duct 210 and a fitting hole 224 of the discharge duct 220. Portion 5A encircled in FIG. 5 shows in detail the coupling of the protrusion 135 with the fitting hole 214, the fitting hole 214 of the air conditioning duct 210 being partially cut away in the view to allow the coupling relation to be easily understood. In detail, the protrusions 135 are provided on the upper and lower surfaces of the housing 130 to perform hook coupling at the inlet 131 and the outlet 132, and the air conditioning duct 210 and the discharge duct 220 have the fitting holes 214 and 224 which correspond to the protrusions 135, so that the housing 130 is coupled to the ducts 210 and 220 through a snap-fitting method. As shown in the drawings, the housing 130 may be fitted into the ducts 210 and 220. However, in contrast, the ducts 210 and 220 may be fitted into the housing 130. In this case, protrusions may be provided on the inner surface of the housing 130, or protrusions may be provided on the ducts 210 and 220 and fitting holes may be formed in the housing 130 as the duct-fastening hook.

Further, a flange-shaped support 133 is provided around each of the inlet 131 and the outlet 132 of the housing 130 and is thus in contact with the outer surface of each of the duct 210 or 220 when the housing 130 is coupled to the duct 210 or 220. The support 133 prevents the undesirable movement of the housing 130, thus preventing the removal of the duct-fastening hook even when the vehicle is being driven. The shape of the support 133 is shown in detail in portion 5B encircled in FIG. 5.

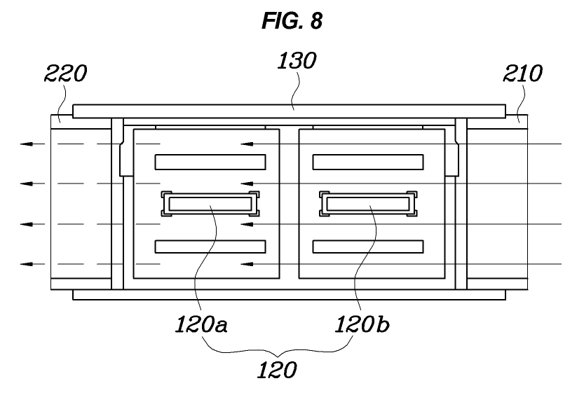

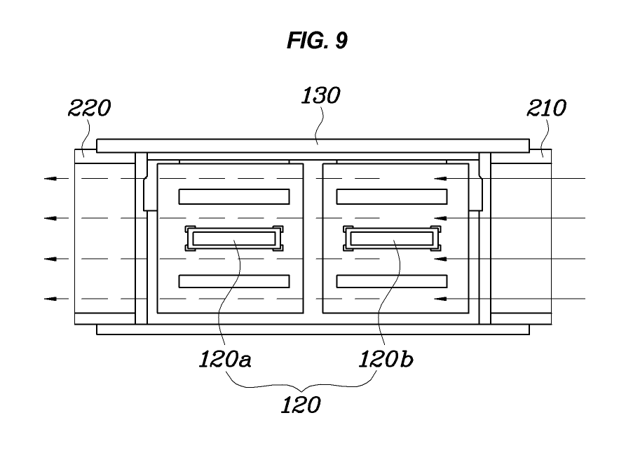

FIGS. 8 and 9 are views illustrating the operation of the pre-heater apparatus for the vehicle. One or more PTC assemblies 120 may be arranged side by side in the heat sink 110. The plurality of PTC assemblies 120 may be constructed to be operated starting from a PTC assembly 120a adjacent to the outlet 132 of the housing 130, depending on how much heat it is required to provide. That is, if not much heating is required, a sufficient heating effect can be achieved only by one PTC assembly. In this case, the PTC assembly placed around the outlet 132 of the housing 130 is operated, thus preventing heated air from unnecessarily transferring heat through the heat sink 110 and maximizing thermal efficiency. Meanwhile, if a lot of heat must be provided, all of the PTC assemblies may be simultaneously operated to perform full heating.

FIG. 8 illustrates the case in which not much heating is required. In this case, the PTC assembly 120a provided adjacent to the outlet 132 is used, while a PTC assembly 120b provided adjacent to the inlet 131 is not used. FIG. 9 illustrates the case in which a lot of heating is required. In this case, all of the PTC assemblies 120a and 120b are used. As such, in order to individually control the plurality of PTC assemblies, the PTC assemblies 120 may be provided, respectively, with the terminal units 121, and power may be independently applied to the respective terminal units 121. Further, how much heating to provide may be determined by manual manipulation from the interior of the vehicle, and may be automatically controlled depending on the temperature of the ambient air in consideration of energy efficiency.

As described above, the present invention provides remarkable effects, which will be described below.

First, the present invention provides a pre-heater apparatus for a vehicle, in which a heat sink is placed in the direction in which air flows, thus increasing heat exchange efficiency even in a narrow space.

Second, the present invention provides a pre-heater apparatus for a vehicle, in which an air path is provided in the longitudinal direction of a heat sink, so that the time that heat is exchanged between air and the heat sink is extended, and thus heating performance is improved.

Third, the present invention provides a pre-heater apparatus for a vehicle, which has a small and compact structure, so that the pre-heater apparatus can be easily installed in even a narrow duct.

Fourth, the present invention provides a pre-heater apparatus for a vehicle, which is accommodated in a duct, so that heat loss can be minimized at the time air passes through the duct. Also, the pre-heater apparatus is mounted to a duct adjacent to a discharge duct, so that the performance of heating the interior can be improved when the vehicle is initially started, and thus the satisfaction of customers can be increased because of an improvement in heating performance.

Fifth, the present invention provides a pre-heater apparatus for a vehicle, which is fastened to a duct by a hook fastening structure, thus making it easy to assemble, and individually controls a plurality of PTC assemblies, thus maximizing heat efficiency.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pre-heater apparatus for a vehicle, comprising:
a heat sink having a plurality of radiating fins which are layered, with an air path formed between the radiating fins;
a Positive Temperature Coefficient (PTC) assembly having a terminal unit for supplying power and a PTC element which receives power from the terminal unit to generate heat, the PTC assembly being inserted into the heat sink and parallel to the air path; and
a housing surrounding the heat sink, and having an inlet and an outlet on first and second ends of the air path in such a way that the inlet and the outlet are opposite to each other, each of the inlet and the outlet including with a duct-fastening hook.

2. The pre-heater apparatus as set forth in claim 1, wherein the housing is disposed between an air conditioning duct in which conditioned air flows and a discharge duct through which the conditioned air is discharged, and each duct-fastening hook of the housing has a snap-fitting protrusion for securing with respective air conditioning and discharge ducts.

3. The pre-heater apparatus as set forth in claim 2, wherein the housing is made of a polymer material having higher resistance to thermal deformation resulting from high temperature than the air conditioning duct and the discharge duct.

4. The pre-heater apparatus as set forth in claim 1, wherein a flange-shaped support is provided around each of the inlet and the outlet of the housing and is in close contact with an outer surface of each of the air conditioning duct and the discharge duct when the housing is coupled to the duct.

5. The pre-heater apparatus as set forth in claim 1, wherein the PTC assembly is disposed in a longitudinal direction of the heat sink and perpendicular to the length of the heat sink.

6. The pre-heater apparatus as set forth in claim 5, wherein a plurality of PTC assemblies are placed side by side in the heat sink.

7. The pre-heater apparatus as set forth in claim 6, wherein the plurality of PTC assemblies are constructed to be sequentially operated starting from a first PTC assembly immediately adjacent to the outlet of the housing, depending on a desired amount of heat.

8. The pre-heater apparatus as set forth in claim 6, wherein the plurality of PTC assemblies comprise terminal units, respectively, power being independently applied to the respective terminal units.

9. The pre-heater apparatus as set forth in claim 1, wherein a plurality of heat sinks is arranged side by side in the housing to define a continuous air path, and PTC assemblies are inserted, respectively, into the corresponding heat sinks in such a way as to be placed in a common plane.
